(19) United States
(12) Patent Application Publication
(10) Pub. No.: US 2001/0034631 A1
(43) Pub. Date: Oct. 25, 2001

(54) Method and apparatus for the automatic selection of parties to an arrangement between a requestor and a satisfier of selected requirements

(76) Inventor: Daniel R. Kiselik, Short Hills, NJ (US)

Correspondence Address: Arthur Jacob, 25 East Salem Street, P.O. Box 686, Hackensack, NJ, 07602, US

(21) Appl. No.: 09/765,511

(22) Filed: Jan. 19, 2001

Related U.S. Application Data
(63) Continuation-in-part of application No. 09/489,233, filed on Jan. 21, 2000.

(51) Int. Cl. G06F 17/60

(52) U.S. Cl. 705/8; 705/10; 705/11; 705/37

(57) ABSTRACT

A method of operating a computer system and a computer system for the automatic selection of parties to an arrangement between a system-qualified requester of selected requirements and a system-qualified satisfier of specific requirements utilizes predetermined composites of criteria representing system-qualified requesters and system-qualified satisfiers to establish a selected group of satisfiers qualified to respond to a particular request for a satisfier entered by a system-qualified requester. Timely responses of system-qualified satisfiers meeting the particular requirements established by the requester are presented to the requester for selection of a satisfier and automatic completion of the arrangement. Subsequent to completion of the arrangement, a rating by the requester of the performance of the satisfier and a rating by the satisfier of the performance of the requester are entered into the computer system for continuous updating of performance ratings.

This is a continuation-in-part of application Ser. No. 09/489,233, filed Jan. 21, 2000.

The present invention relates generally to particular arrangements between requesters and satisfiers of selected requirements and pertains, more specifically, to the use of a computerized system and method for automatically selecting the parties to such arrangements.

An expanding world-wide market for goods and services as well as for other specific requirements presents ever-increasing numbers of buyers and sellers available for the completion of sales transactions as well as other requesters and satisfiers for the completion of arrangements involving selected requirements in a myriad of fields. A buyer or seller wishing to enter a market is faced with an almost unlimited number of choices in finding a party best suited to completing a particular sales transaction. Likewise, a requester of selected requirements has many choices of satisfiers of such requests. The availability of a network universally accessible by computers provides opportunities not attainable by manually operated business models. While many systems have been proposed for matching buyers and sellers of goods and services, based upon various criteria established by the parties to particular transactions, enabling narrowing of the field of potential buyers and sellers to the most promising parties available for a particular transaction, the present invention facilitates the automatic selection of parties and the automatic completion of a sales transaction between the selected parties, as well as other arrangements between a requester and a satisfier, enabling increased accuracy with minimal time and effort, and concomitant decreased cost, in effecting an arrangement which meets criteria established by both the parties in a particular market. The completion of the transaction or arrangement in the present invention is effected automatically, thereby conserving the time and resources of the parties in accomplishing an arrangement meeting all of the requirements of both parties. The result is improved profitability for the seller and lower pricing for the buyer, and better matching of satisfiers with a requester, all accomplished automatically.

As such, the present invention attains several objects and advantages, some of which are summarized as follows: Automatically selects parties for a particular transaction or arrangement, from qualified requesters and satisfiers, such as qualified buyers and qualified sellers available in a market for goods or services; takes into account composites of criteria established by both requesters and satisfiers, such as buyers and sellers, in order to effect rapid and accurate selection of parties to a particular arrangement, such as a sales transaction; enables an evaluation based upon past performance of potential parties to an arrangement, such as a transaction in the automatic selection of parties to a particular transaction; provides increased flexibility in completing an arrangement, such as a transaction between selected parties to a sales transaction; facilitates completion of a particular sales transaction through automatically furnishing proprietary items, such as technical data, as well as detailed specifications pertinent to the transaction; enables a purchaser to obtain rapid and accurate fulfillment of specific purchase requests at an advantageous price in fields which offer a multiplicity of suppliers; attains improved profitability for suppliers; reduces transaction costs for both buyers and sellers; promotes a dynamic system which evolves continually into a more effective selection of parties to a particular arrangement; provides a reliable system for effecting automatic transactions between buyers and sellers of goods or services at more advantageous prices and conditions.

The above objects and advantages, as well as further objects and advantages, are attained by the present invention which may be described briefly as a method of operating a computer system for the automatic selection of parties to an arrangement between a system-qualified requester of selected requirements and a system-qualified satisfier of specific requirements, the method comprising the steps of: inputting into the computer system a first predetermined composite of criteria representing each requester qualified to enter the computer system as a system-qualified requester; inputting into the computer system a second predetermined composite of criteria representing each satisfier qualified to serve as a system-qualified satisfier in the computer system, the second predetermined composite of criteria including satisfaction criteria pertaining to the ability of the satisfier to satisfy specific requirements, and requesting criteria pertaining to requirements of the satisfier in a particular arrangement in order for the satisfier to enter into an arrangement with a particular requester; entering into the computer system a request for a satisfier by a requester identified as a system-qualified requester, the request for a satisfier including a schedule of requirements established by the system-qualified requester; comparing in the computer system the schedule of requirements with the satisfaction criteria of the second predetermined composite of criteria to establish a selected group of system-qualified satisfiers able to meet the schedule of requirements; comparing in the computer system the requesting criteria of each satisfier of the selected group of system-qualified satisfiers with the first predetermined composite of criteria to establish a sub-group of satisfiers willing to enter into an arrangement with the system-qualified requester entering the request for a satisfier; outputting from the computer system the request for a satisfier for submission to the sub-group of system-qualified satisfiers for timely responses by satisfiers of the sub-group of system-qualified satisfiers; inputting into the computer system timely responses by responding satisfiers of the sub-group of system-qualified satisfiers, and outputting from the computer system the timely responses inputted by the responding satisfiers for selection by the requester of a response from among those timely responses inputted by responding satisfiers; inputting into the computer system a requester selected response and outputting from the computer system the requester selected response to notify the satisfier corresponding to the selected response of the selection of the selected response by the requester; and outputting from the computer system to the requester the identity of the satisfier and outputting from the computer system to the satisfier the identity of the requester for completion of the arrangement.

In addition, the present invention includes a computer system operated for the automatic selection of parties to an arrangement between a system-qualified requester of selected requirements and a system-qualified satisfier of specific requirements, the computer system comprising: an inputting device for: inputting into the computer system a first predetermined composite of criteria representing each requester qualified to enter the computer system as a system-qualified requester; inputting into the computer system a second predetermined composite of criteria representing each satisfier qualified to serve as a system-qualified satisfier in the computer system, the second predetermined composite of criteria including satisfaction criteria pertaining to the ability of the satisfier to satisfy specific requirements, and requesting criteria pertaining to requirements of the satisfier in a requester in order for the satisfier to enter into an arrangement with a particular requester; and entering into the computer system a request for a satisfier by a requester identified as a system-qualified requester, the request for a satisfier including a schedule of requirements established by the system-qualified requester; such that the computer system compares: the schedule of requirements with the satisfaction criteria of the second predetermined composite of criteria to establish a selected group of system-qualified satisfiers able to meet the schedule of requirements; and the first predetermined composite of criteria with the requesting criteria of each satisfier of the selected group of system-qualified satisfiers to establish a sub-group of satisfiers willing to enter into an arrangement with the system-qualified requester entering the request for a satisfier; and an outputting device for: outputting from the computer system the request for a satisfier for submission to the sub-group of system-qualified satisfiers for timely responses by satisfiers of the sub-group of system-qualified satisfiers; the inputting device further being operative for: inputting into the computer system timely responses by responding satisfiers of the sub-group of system-qualified satisfiers, and outputting from the computer system the timely responses inputted by the responding satisfiers for selection by the requester of a response from among those timely responses inputted by responding satisfiers; and inputting into the computer system a requester selected response and outputting from the computer system the requester selected response to notify the satisfier corresponding to the selected response of the selection of the selected response by the requester; and the outputting device further being operative for: outputting from the computer to the requester the identity of the satisfier and outputting from the computer to the satisfier the identity of the requester for completion of the arrangement.

Further, the present invention includes an improvement in a method of operating a computer system for the automatic selection of parties to an arrangement to be completed between a system-qualified requestor of selected requirements and a system-qualified satisfier of specific requirements, wherein a first predetermined composite of criteria representing each requester qualified to enter the computer system as a system-qualified requester is inputted into the computer system and a second predetermined composite of criteria representing each satisfier qualified to serve as a system-qualified satisfier in the computer system is inputted into the computer system, the second predetermined composite of criteria including satisfaction criteria pertaining to the ability of the satisfier to satisfy specific requirements, and requesting criteria pertaining to requirements of the satisfier in a particular arrangement in order for the satisfier to enter into an arrangement with a particular requester, the improvement comprising: inputting into the computer system, subsequent to completion of the arrangement, a rating by the requester of the performance of the satisfier, and including the rating in the satisfaction criteria of the second predetermined composite of criteria. In addition, subsequent to completion of the arrangement, a rating by the satisfier of the performance of the requester may be inputted into the computer system and included in the first predetermined composite of criteria.

Still further, the present invention includes in a computer system operated for the automatic selection of parties to an arrangement to be completed between a system-qualified requester of selected requirements and a system-qualified satisfier of specific requirements, wherein an inputting device is operative for inputting into the computer system a first predetermined composite of criteria representing each requester qualified to enter the computer system as a system-qualified requester and a second predetermined composite of criteria representing each satisfier qualified to serve as a system-qualified satisfier in the computer system, the second predetermined composite of criteria including satisfaction criteria pertaining to the ability of the satisfier to satisfy specific requirements, and requesting criteria pertaining to requirements of the satisfier in a particular arrangement in order for the satisfier to enter into an arrangement with a particular requester, the improvement wherein: the inputting device is further operative for inputting into the computer system, subsequent to completion of the arrangement, a rating by the requester of the performance of the satisfier, and including the rating in the satisfaction criteria of the second predetermined composite of criteria. In addition, the inputting device can be further operative for inputting into the computer system, subsequent to completion of the arrangement, a rating by the satisfier of the performance of the requester, and including the rating in the first predetermined composite of criteria.

The invention will be understood more fully, while still further objects and advantages will become apparent, in the following detailed description of preferred embodiments of the invention illustrated in the accompanying drawing, in which:

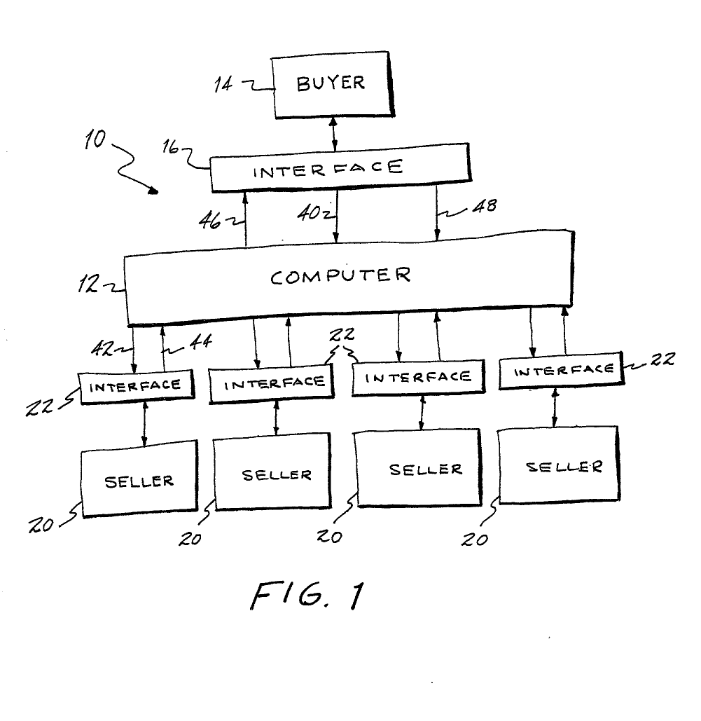

FIG. 1 is a block diagram of a system constructed and operated in accordance with the present invention;

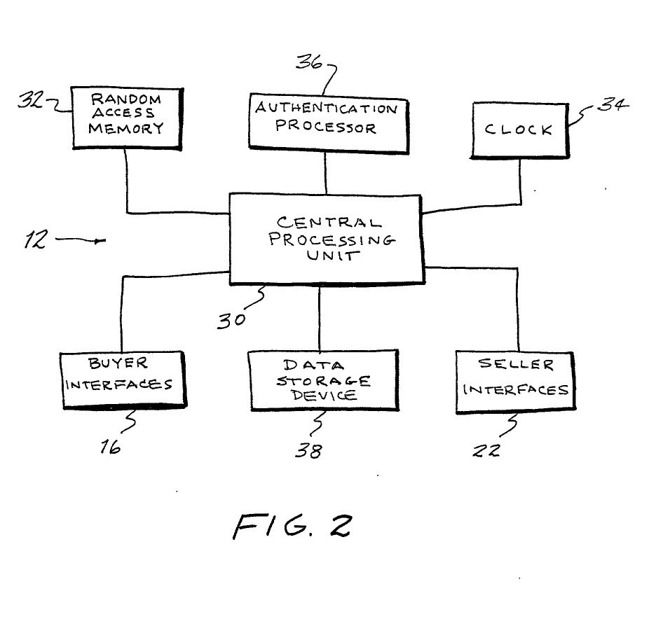

FIG. 2 is a block diagram of a portion of the system;

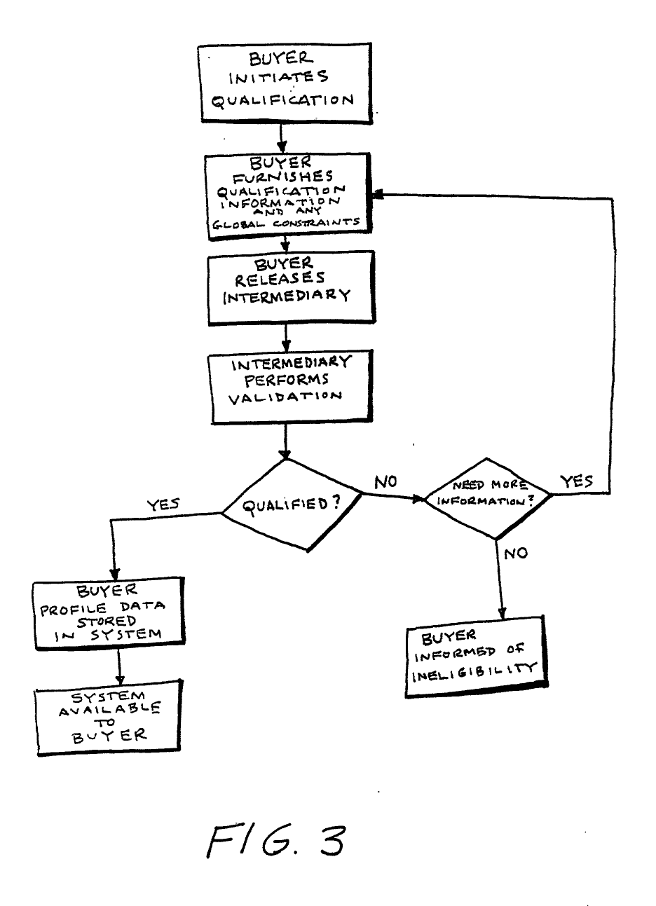

FIG. 3 is a flow chart illustrating an initial portion of the operation of the system;

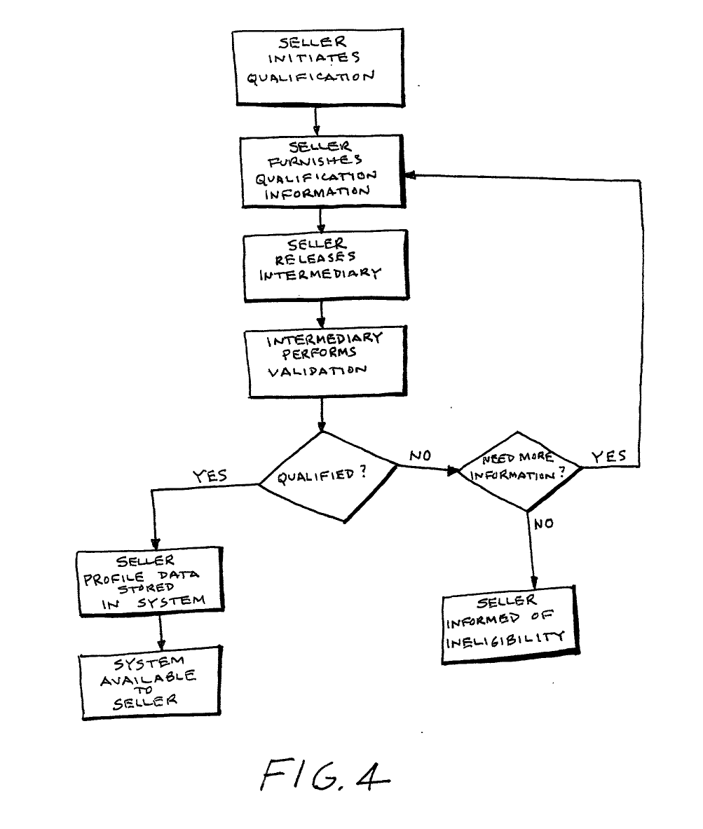

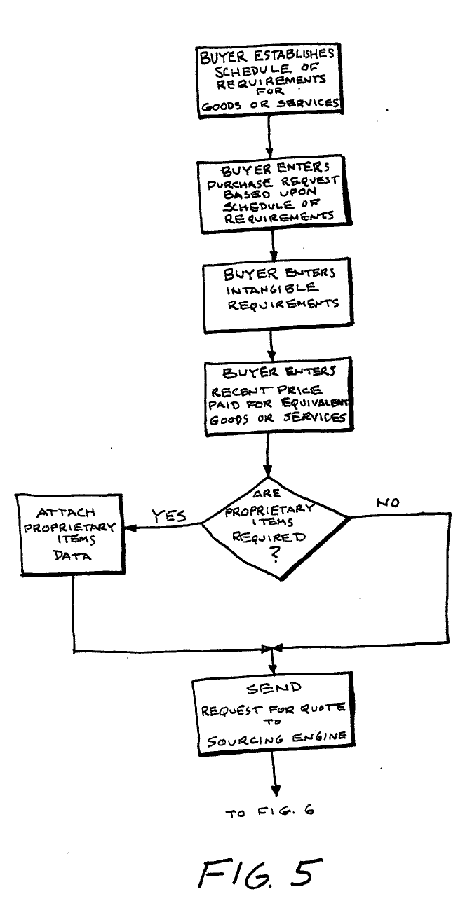

FIG. 4 is a flow chart illustrating another initial portion of the operation of the system;

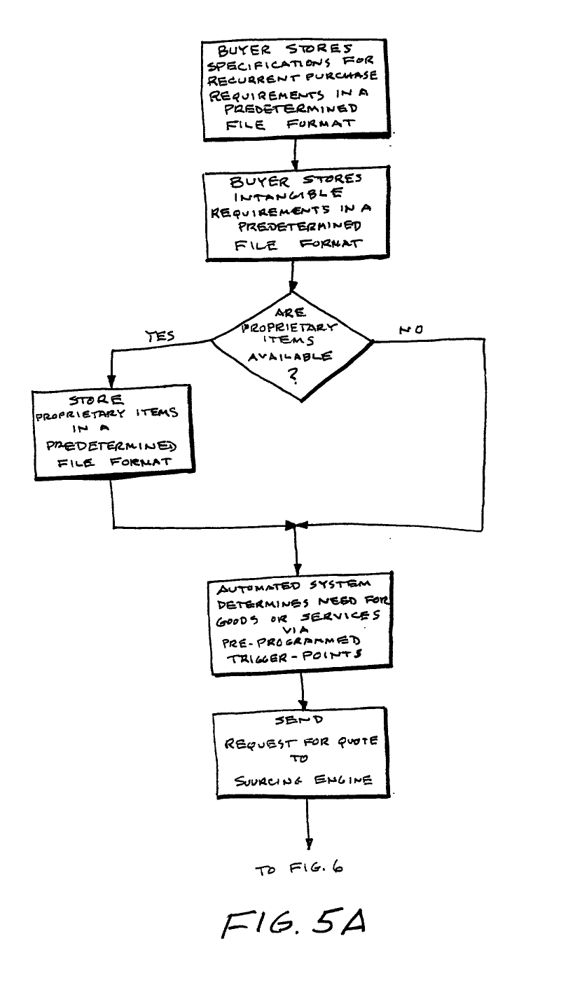

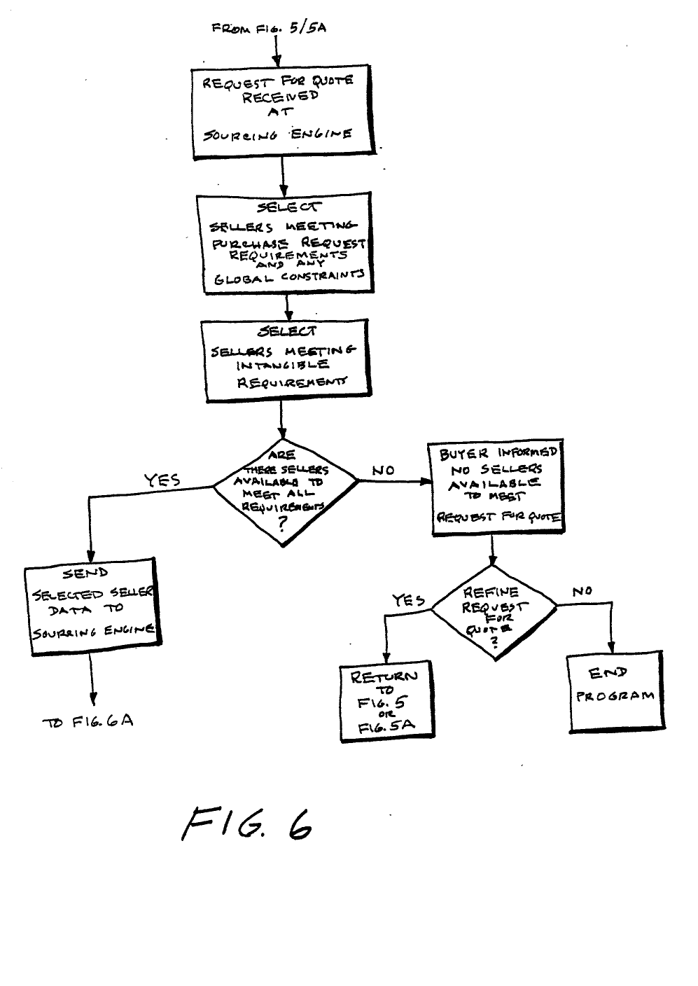

FIG. 5 is a flow chart illustrating a further portion of the operation of the system;

FIG. 5A is a flow chart illustrating an alternate further portion of the operation of the system;

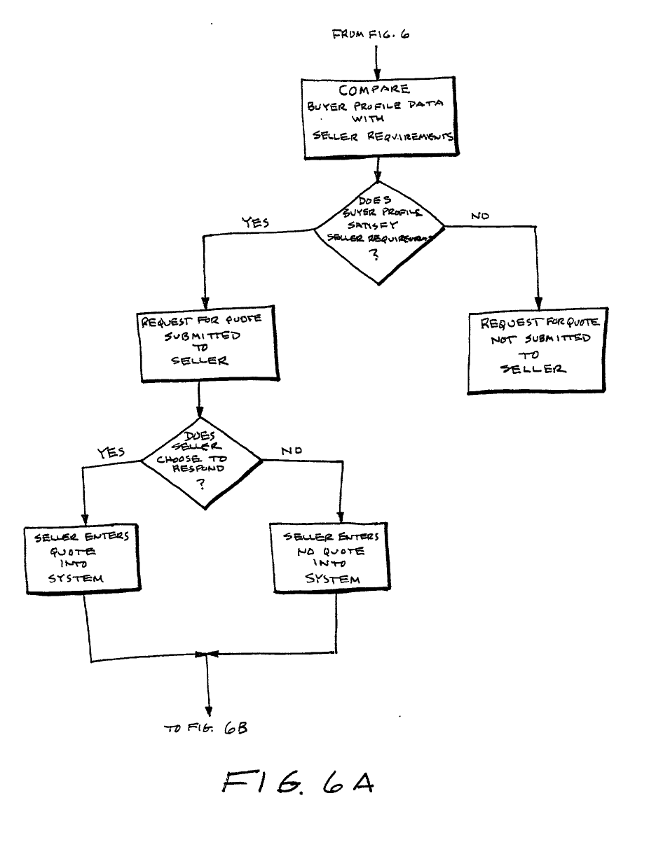

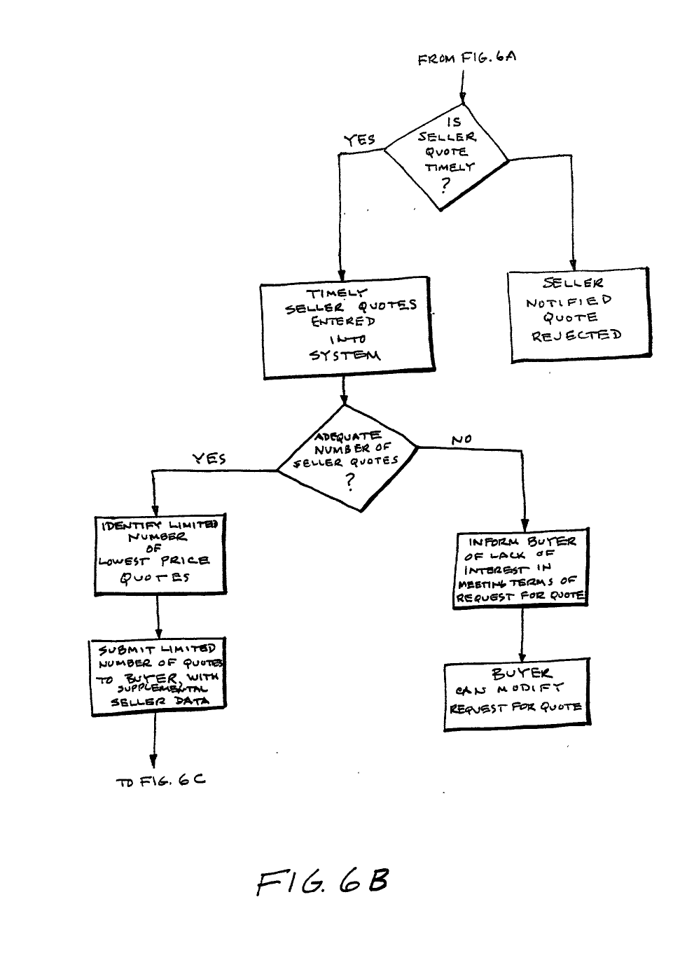

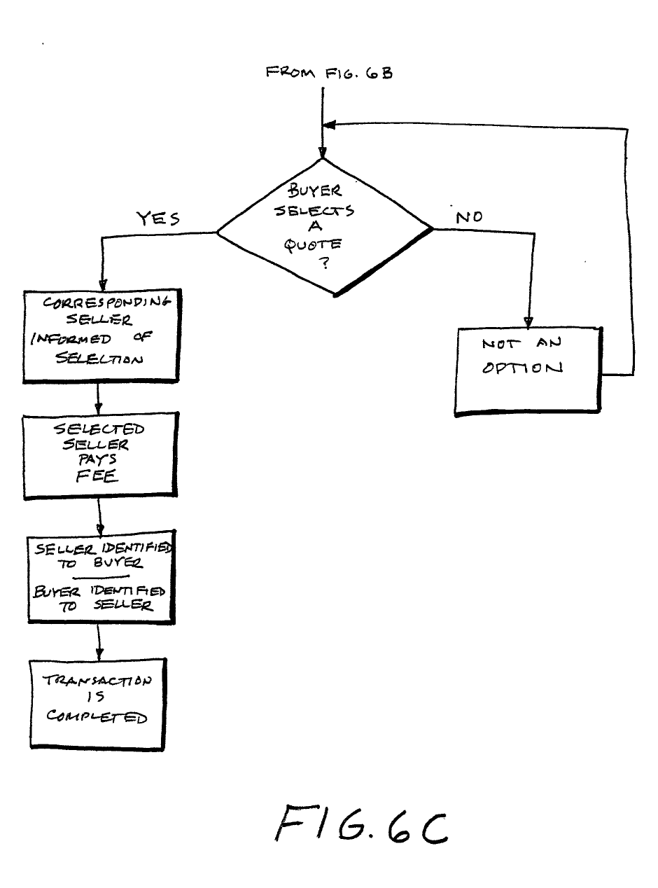

FIGS. 6 through 6C comprise a flow chart illustrating continued portions of the operation of the system;

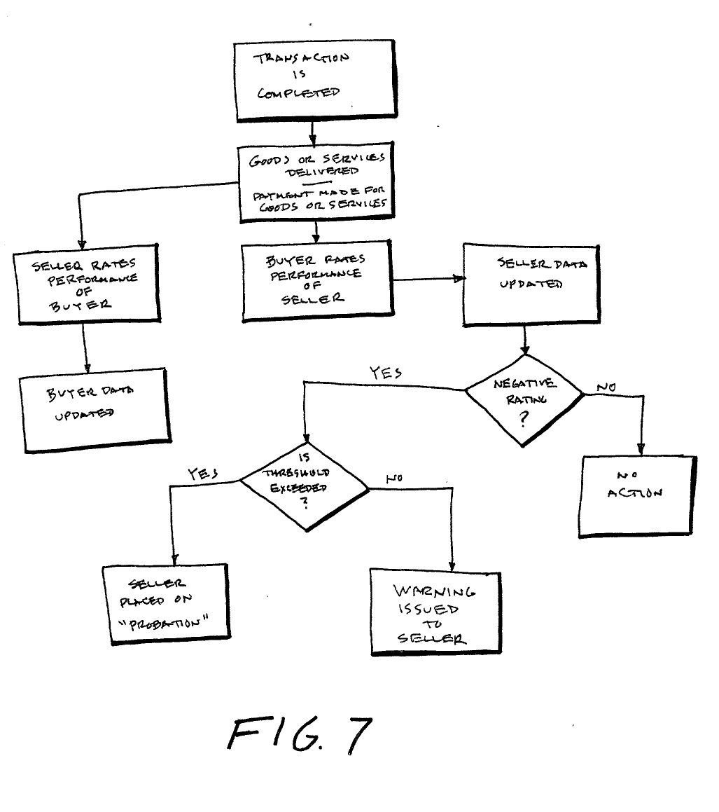

FIG. 7 is a flow chart illustrating the operation of a further feature of the system;

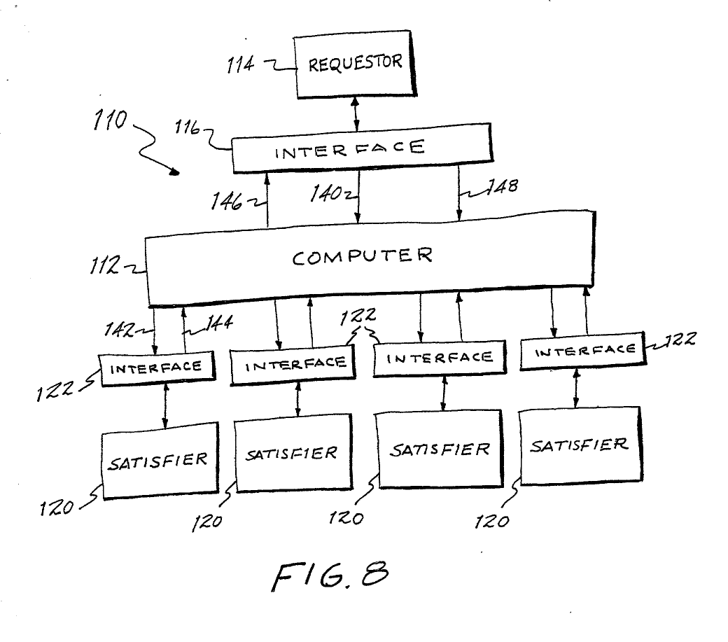

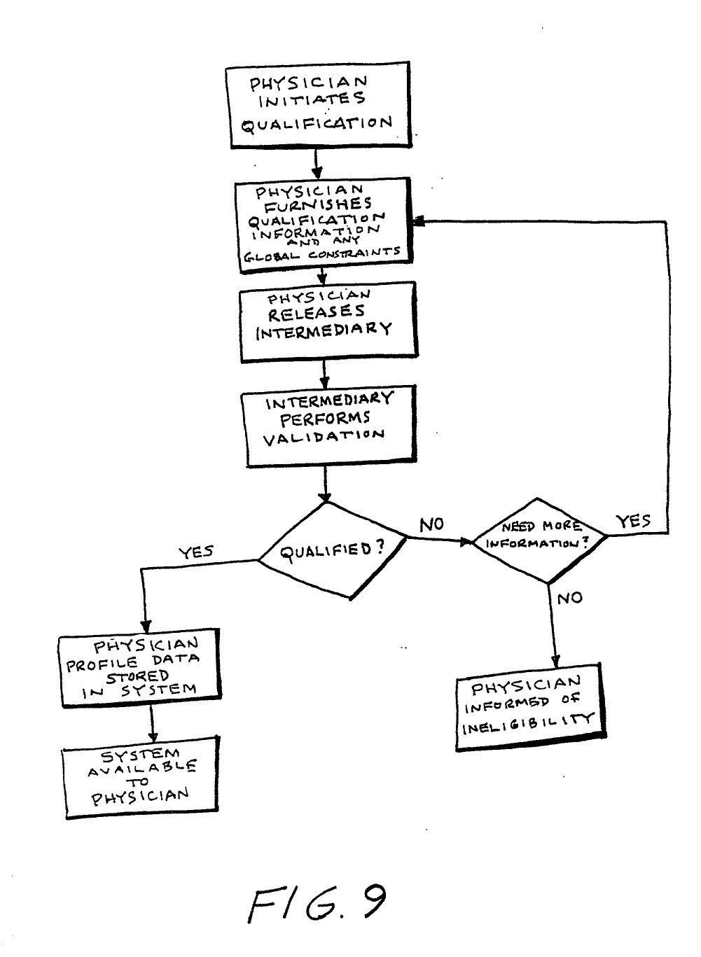

FIG. 8 is a block diagram of another system constructed and operated in accordance with the present invention;

FIG. 9 is a flow chart illustrating an initial portion of the operation of the system of FIG. 8;

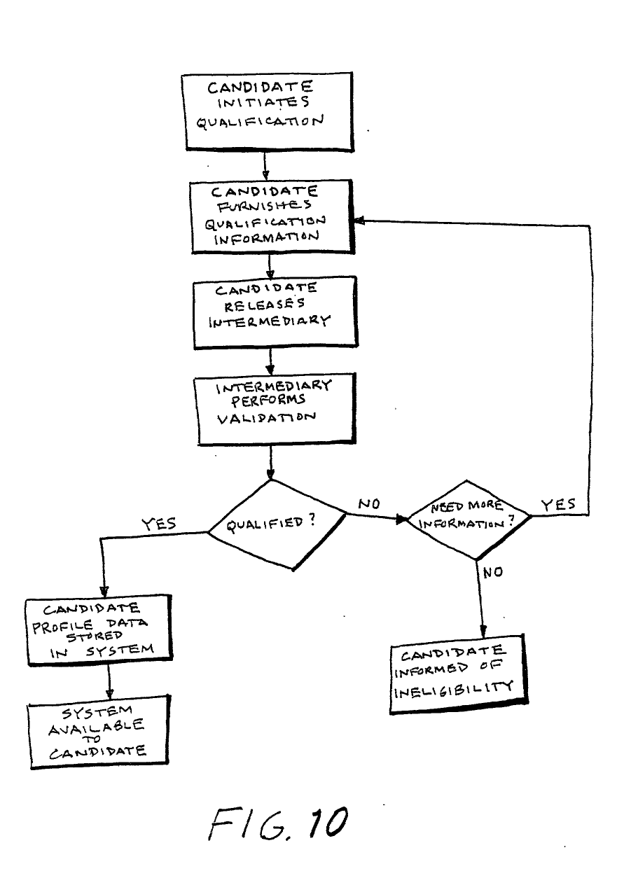

FIG. 10 is a flow chart illustrating another initial portion of the operation of the system;

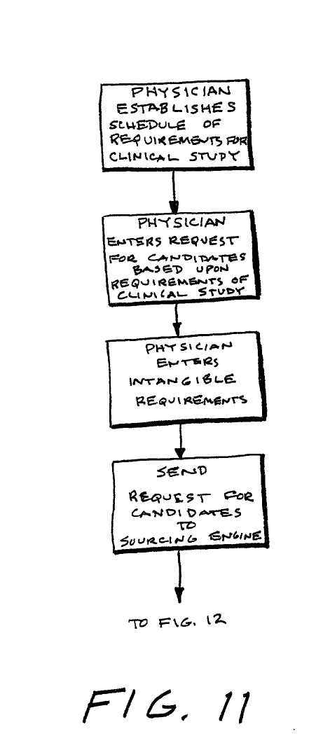

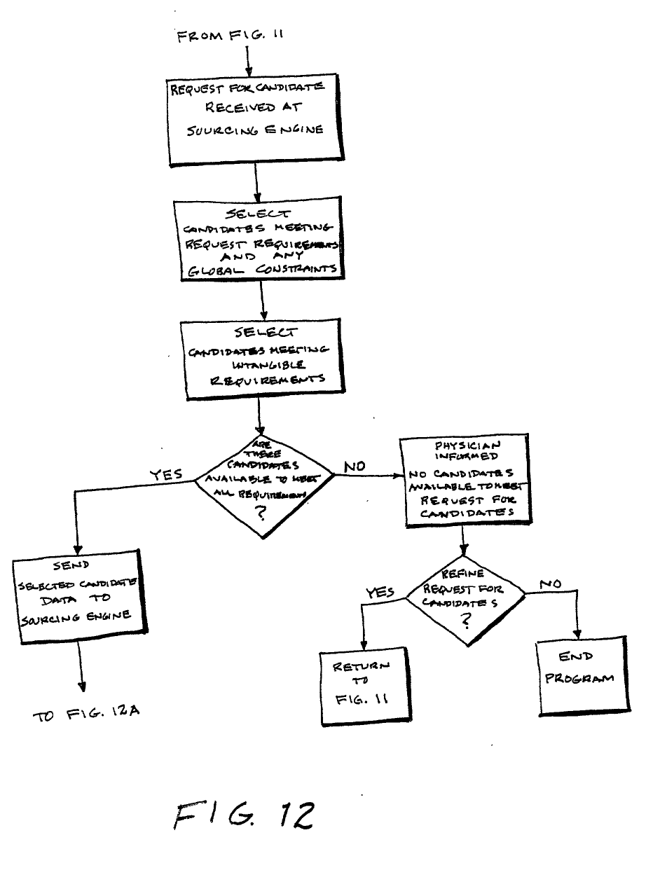

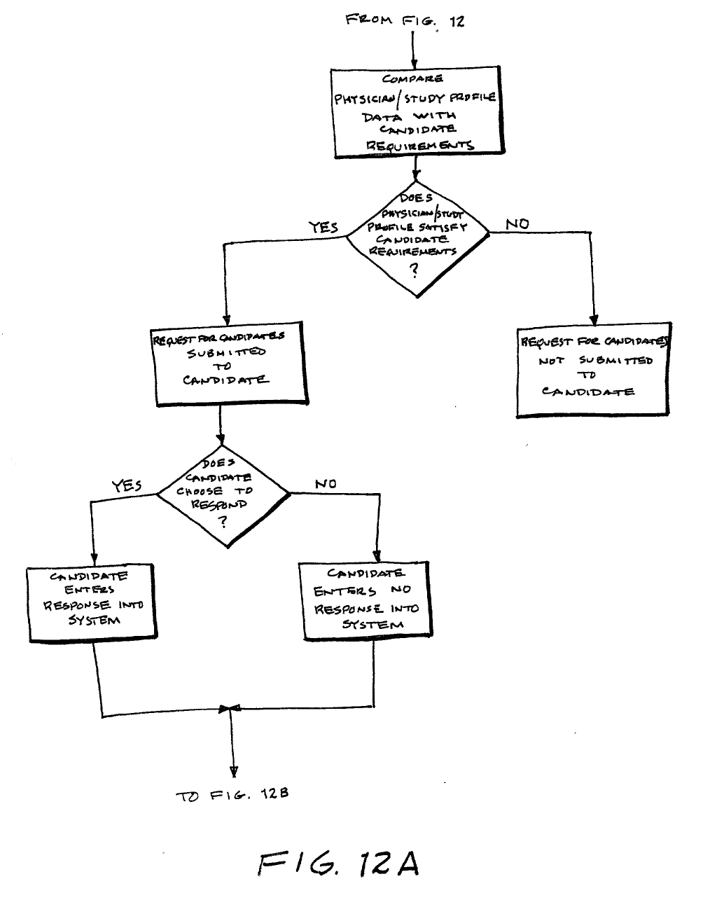

FIG. 11 is a flow chart illustrating a further portion of the operation of the system;

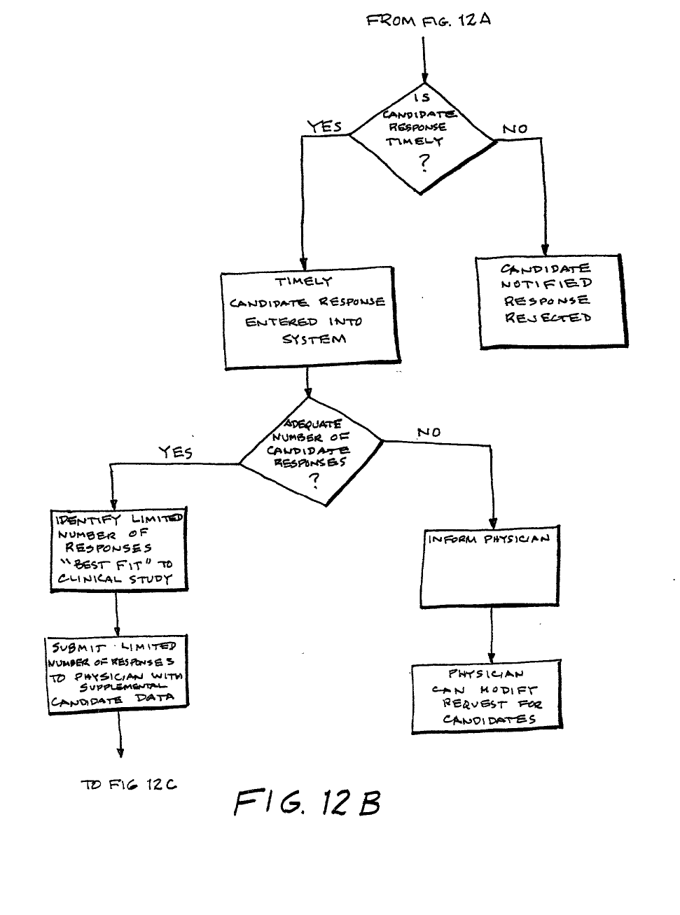

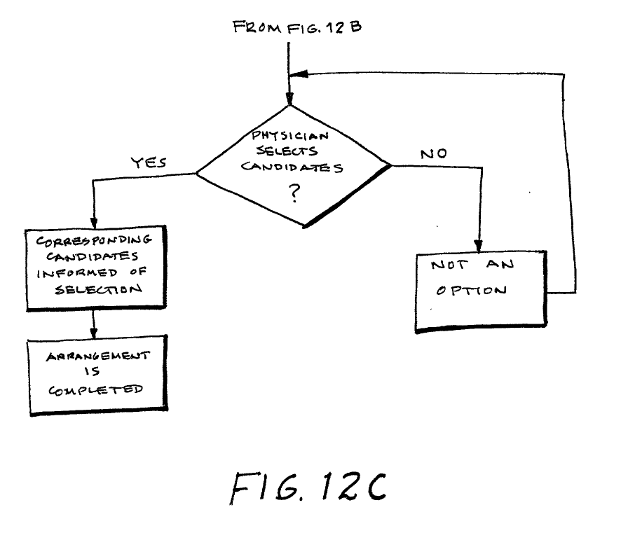

FIGS. 12 through 12C comprise a flow chart illustrating continued portions of the operation of the system;

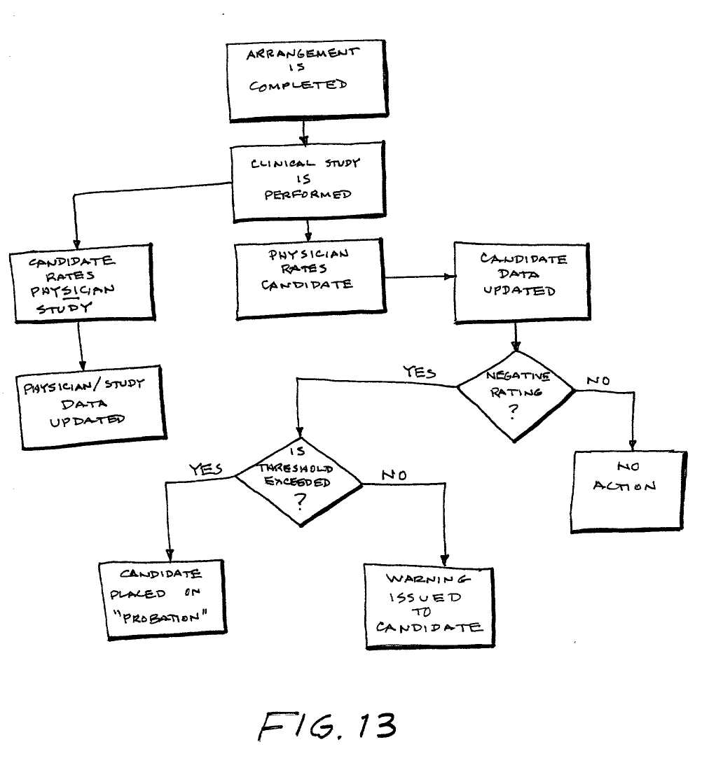

FIG. 13 is a flow chart illustrating the operation of a further feature of the system;

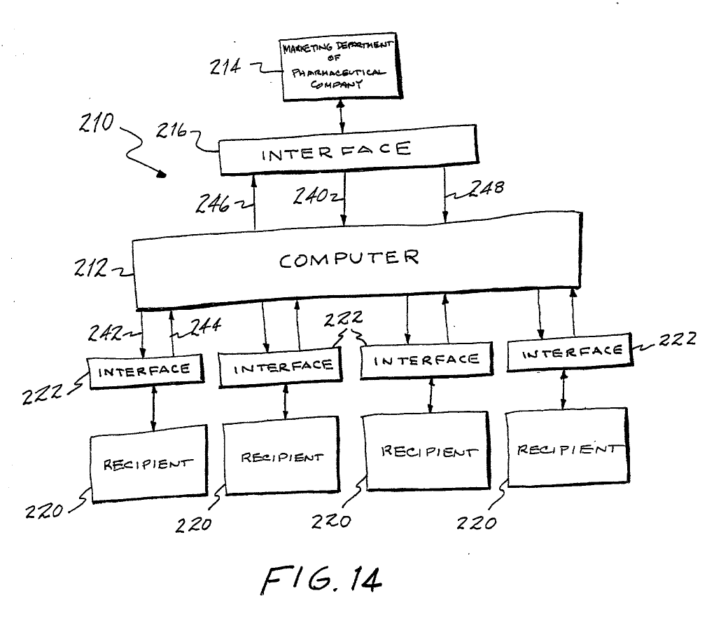

FIG. 14 is a block diagram of still another system constructed and operated in accordance with the present invention;

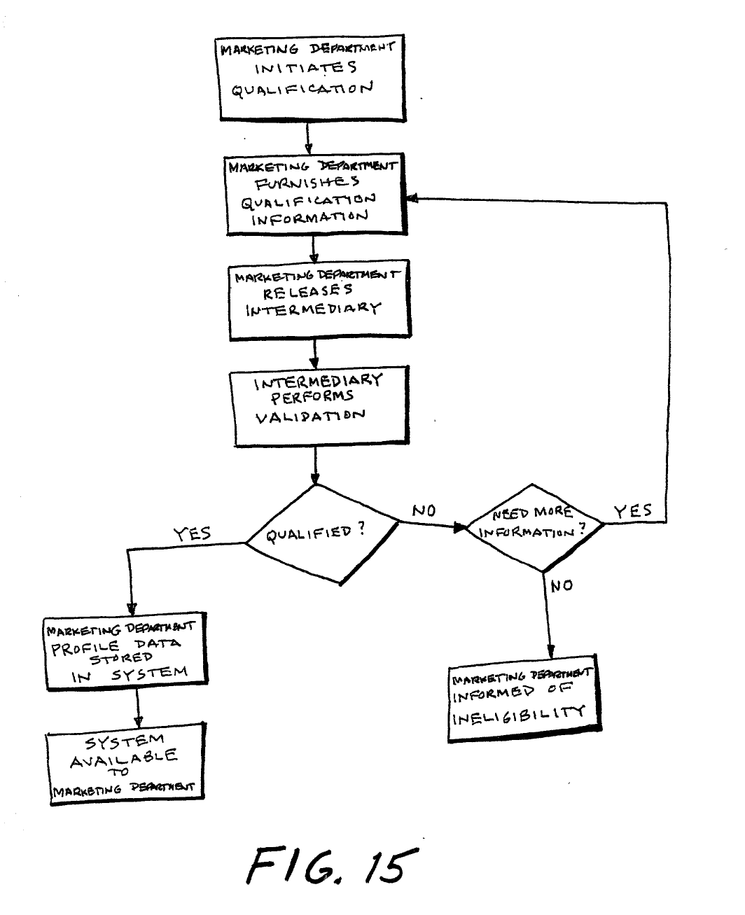

FIG. 15 is a flow chart illustrating an initial portion of the operation of the system of FIG. 14;

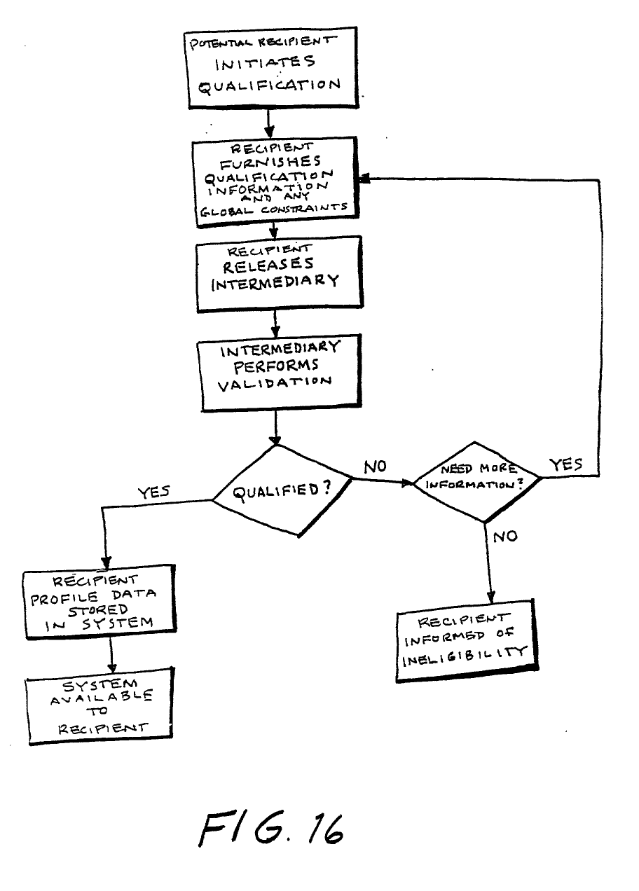

FIG. 16 is a flow chart illustrating another initial portion of the operation of the system;

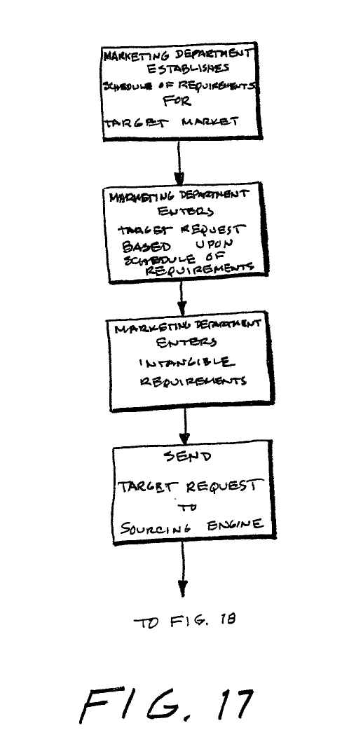

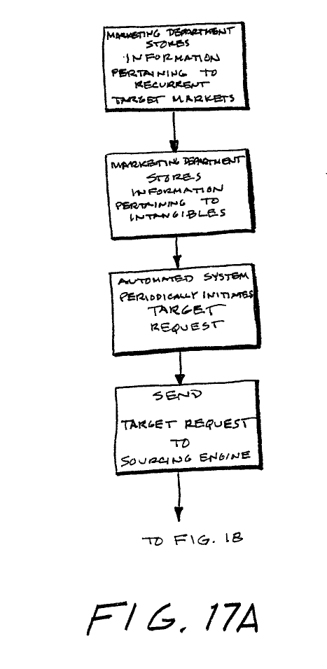

FIG. 17 is a flow chart illustrating a further portion of the operation of the system;

FIG. 17A is a flow chart illustrating an alternate further portion of the operation of the system;

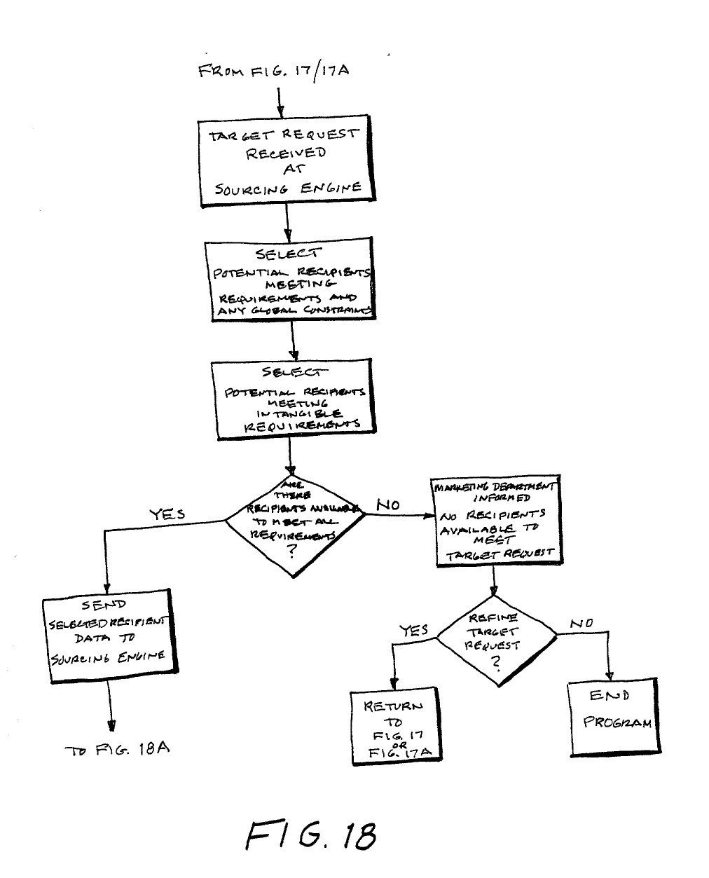

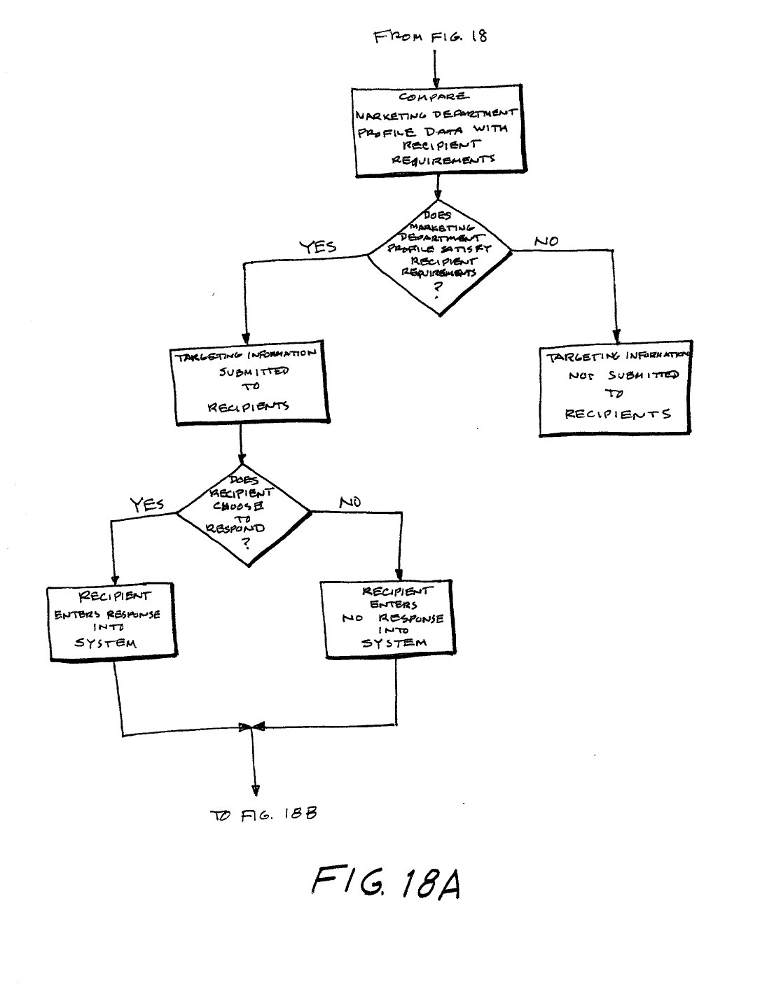

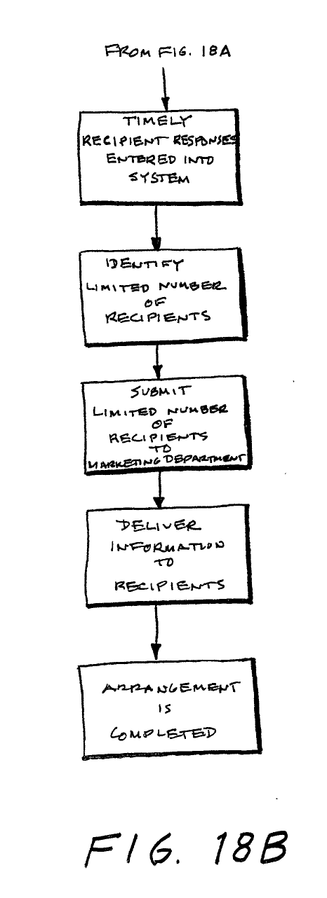

FIGS. 18 through 18B comprise a flow chart illustrating continued portions of the operation of the system; and

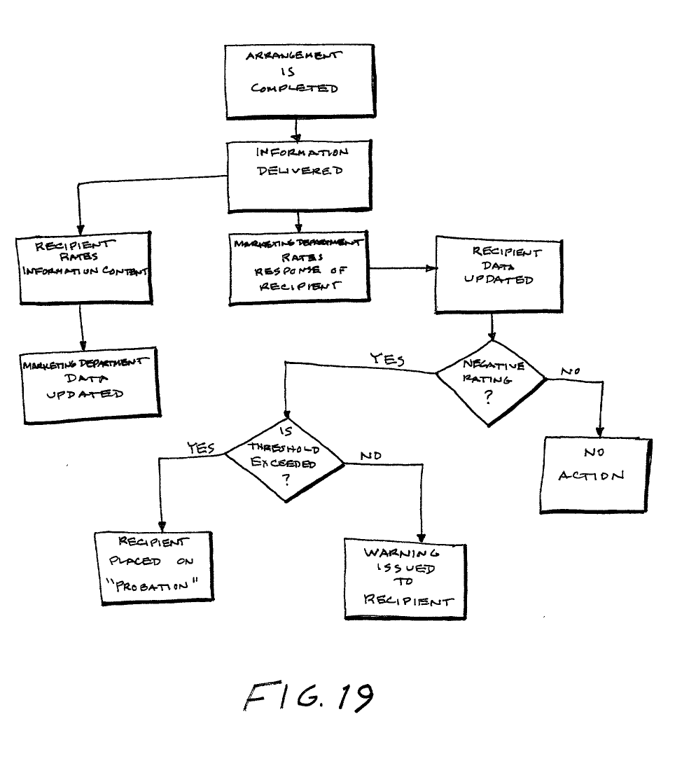

FIG. 19 is a flow chart illustrating the operation of a further feature of the system.

Referring now to the drawing, and especially to FIGS. 1 and 2 thereof, a system constructed and operated in accordance with the present invention is shown diagrammatically at 10 and is seen to include a computer 12 linked to a buyer input device shown in the form of a buyer terminal 14 through a buyer interface 16 and linked to a number of seller input devices shown in the form of seller terminals 20 through corresponding seller interfaces 22. These input devices may be in the form of PC's, remote computer systems, hand-held devices, cellular telephones, and the like. While the diagram of FIG. 1 shows only one buyer terminal 14 and only four seller terminals 20, the number of terminals shown is for illustrative purposes only, it being understood that an essentially unlimited number of terminals can be linked to the computer 12 for operation of the system of the present invention. As seen in FIG. 2, the computer 12 includes a central processing unit (CPU) 30, a random access memory (RAM) 32, a clock 34, an authentication processor 36, and a data storage device 38, and is operated in the manner set forth hereinafter.

In order to enter the system of the present invention, a potential buyer of goods or services must first be qualified to serve as a party to a transaction accomplished by the system. Likewise, a potential seller of goods or services must be qualified in order to be made available as a party in the system. Turning now to FIG. 3, a buyer may become system-qualified by inputting into the computer 12 qualification information in the form of a first predetermined composite of criteria representing the buyer. The composite of criteria includes information about the buyer and is entered into the computer 12 in a standardized format. The information may be composed of both public information and non-public information. The information is verified and may be combined with further information furnished by an outside source to establish a more complete composite of criteria pertaining to the buyer. The verification, or validation, preferably is accomplished by an intermediary, upon release of the intermediary by the buyer to perform such validation. If, as a result of the validation process, it is determined that more information is required, the buyer is informed and may enter the required information. If the validation process indicates that the buyer cannot be qualified to enter the system, the buyer is notified of the buyer's ineligibility. Upon completion of a successful validation process, the complete composite of criteria pertaining to the buyer, in the form of a buyer profile, is generated and stored in the system 10 as a buyer database in the data storage device 38. The composite of criteria, or buyer profile, may include, but is not limited to, such information as credit rating, financial strength, years in business, size of buyer organization, and geographic location. In addition, the buyer may choose to include certain global constraints, such as minimum quality requirements, regulatory requirements, minimum desired financial strength in a potential seller, and like constraints which will be common to all requests to be entered into the system by the buyer. The system now is available for use by the system-qualified buyer.

Referring now to FIG. 4, a seller may become system-qualified by inputting into the computer 12 qualification information in the form of a second predetermined composite of criteria representing the seller. The second composite of criteria includes information about the seller and is entered into the computer 12 in a standardized format. The information may be composed of both public and non-public information. The second composite of criteria includes vendor criteria pertaining to the ability of the seller to deliver particular goods or services, and vending criteria pertaining to requirements of the seller in a particular transaction in order for the seller to sell to a particular buyer. The vendor criteria may include, but are not limited to, available equipment, average inventory levels of critical supplies, capacity for filling orders, debt levels, cash-flow information, and the like. The vending criteria may include, but are not limited to, buyer characteristics as well as sale characteristics required by the seller before the seller will agree to do business with a particular buyer in a particular transaction. The information is verified and may be combined with further information furnished by an outside source to establish a more complete composite of criteria pertaining to the seller. The verification, or validation, preferably is accomplished by an intermediary, upon release of the intermediary by the seller to perform such validation. If, as a result of the validation process, it is determined that more information is required, the seller is informed and may enter the required information. If the validation process indicates that the seller cannot be qualified to enter the system, the seller is notified of the seller's ineligibility. Upon completion of a successful validation process, the complete composite of criteria pertaining to the seller, in the form of a seller profile, is generated and stored in the system 10 as a seller database in the data storage device 38. The composite of criteria, or seller profile, thus may include, but is not limited to, such information as ability to deliver, credit rating, financial strength, years in business, size of seller organization, and geographic location. The seller now is available to participate in the system as a system-qualified seller.

Turning now to FIG. 5, a system-qualified buyer establishes a schedule of requirements required by the buyer for the purchase of goods or services and enters a purchase request based upon those requirements. The requirements may include, among other conditions, job specifications, job quantity, turn-around time, quality level, quality control requirements, and delivery logistics, and might even identify a specific seller or sellers to be excluded from consideration. In addition, the schedule of requirements specifies a fixed time by which a potential seller must respond to the purchase request. As seen in FIG. 1, the request is entered at 40 via a buyer interface 16 which may utilize the world-wide web, a predetermined E-mail format, or by some ubiquitous manner tied into the buyer's own computer system to transmit the purchase request to the computer 12. Utilizing authentication data stored in the data storage device 38, the authentication processor 36 confirms the identity of the buyer and then allows the entry of detailed specifications pertaining to the purchase. The buyer also enters certain desirable intangible factors and/or constraints, such as, but not limited to, size of the seller organization, geographic location, financial strength of the seller organization, sales volume of the seller organization, years in business, legal status, credit rating, and past performance. In addition, the buyer enters a recent price paid for equivalent goods or services, if such information is available, together with a percentage allowance for price increases, if any. A need date for both pricing and delivery also is entered. Proprietary items, such as engineering drawings, technical specifications, or the like may be included, as required. All of the information then is forwarded to a sourcing engine in the form of a request for a quote (RFQ).

In one alternate available procedure depicted in FIG. 5A, the buyer stores recurrent purchase requirements in a predetermined file format, stores intangible factors in a predetermined file format, and stores proprietary items, such as engineering drawings, technical specifications, and the like, where required, in an acceptable format. An automated system maintained by the buyer determines when a need arises for goods or services and, via pre-programmed trigger-points, forwards information pertaining to the purchase requirements, including the fixed time by which a potential seller must respond to the purchase request, the intangible factors, and the proprietary items, such as engineering drawings, technical specifications, or the like, if applicable, to the sourcing engine in the form of a request for a quote (RFQ). The procedures of both FIGS. 5 and 5A are available for a buyer's use, either in the alternative or in combinations suited to particular transactions.

As seen in FIGS. 6 through 6C, the request for a quote received at the sourcing engine is processed in the computer 12 to determine if there are any system-qualified sellers available in the system for filling the purchase request by being able to meet the schedule of requirements portion of the request for a quote, and then to determine if any such available sellers meet the intangible factors included in the request for a quote. If there are no such sellers available in the system, the buyer is informed of that fact and is given an opportunity to refine the request for a quote and resubmit the refined request for a quote. If there are system-qualified sellers available in the system able to meet all of the requirements set forth in the request for a quote, these system-qualified sellers are placed in a selected group established by comparing in the computer 12 the schedule of requirements provided by the buyer with the vendor criteria of the second predetermined composite of criteria entered by each of the sellers. Then the vending criteria of each seller of the selected group of system-qualified sellers is compared, in the computer 12, to the first predetermined composite of criteria representing the buyer. The vending criteria may include, but are not limited to, credit rating, financial strength, years in business, size of buying organization, size of order, geographic location of buyer, complexity of order, required lead-time, and past performance of buyer in the system. A particular buyer may be identified to be excluded from consideration. Where the first predetermined composite of criteria does not meet the vending criteria of a seller of the selected group, the purchase request is not submitted to that seller. Where the first predetermined composite of criteria does meet the vending criteria of a seller, the seller is included in a sub-group of system-qualified sellers willing to sell to the system-qualified buyer entering the purchase request. The request for a quote then is outputted from the computer 12 to each seller in the sub-group, as illustrated at 42 in FIG. 1, and the sellers are given an opportunity to respond to the request for a quote. The sellers in the sub-group are provided with the fixed time by which a response is required.

Timely responses by the sellers in the sub-group are inputted into the computer 12, as shown at 44 in FIG. 1, the responses including either a price quote or no quote. Should a price quote response not be timely, the response is rejected and the corresponding seller is notified automatically that the seller's quote is rejected by the system. If an adequate number of timely price quotes are not received, the buyer is notified of the lack of interest in the purchase request as set forth by the buyer and the buyer is given an opportunity to modify the purchase request and resubmit the modified purchase request. For example, where the schedule of requirements in the purchase request includes a price which the system-qualified buyer is willing to pay, and a preset deviation from that price, the buyer is given an opportunity to expand the deviation for resubmission to the system. Likewise, where the schedule of requirements in the purchase request includes a desired delivery schedule, the buyer is given an opportunity to modify the delivery schedule for resubmission. If an adequate number of price quotes are received, a limited number of these price quotes are outputted for submission to the buyer, as indicated at 46 in FIG. 1, based primarily upon the lowest price quotes, but including such factors as performance history and financial strength of the corresponding sellers. The limited number preferably is selected to be a relatively low number, such as, for example, three, so as to reduce the complexity of choice and accelerate the selection process. The price quotes submitted to the buyer include a rating and a history of performance of each corresponding seller in previous transactions. The buyer then selects one of the price quotes. Up to this point, the identity of the buyer remains unknown to the seller and the identity of the seller remains unknown to the buyer. Upon inputting the price quote selected by the buyer, as depicted at 48 in FIG. 1, the buyer's selection of a seller is outputted and is transmitted to the selected seller, all while still maintaining the anonymity of both the buyer and the seller. The seller then pays a fee to the system. Upon receipt of payment, the system releases the identity of the seller to the buyer and the identity of the buyer to the seller for completion of the transaction. Additionally, any stored proprietary items, such as digital artwork, CAD drawings, CAM programs, formulae, technical specifications, and the like, are downloaded to the seller in accordance with the buyer's request.

Referring now to FIG. 7, in the preferred system, upon completion of the transaction, the buyer is obligated to rate the performance of the seller and the seller is obligated to rate the performance of the buyer. The performance rating of the buyer by the seller is inputted into the computer 12 and the data pertaining to the buyer, which is stored in the data storage device 38, reflected in the first predetermined composite of criteria, is updated accordingly. The performance rating of the seller by the buyer is inputted into the computer 12 and the data pertaining to the seller, which is stored in the data storage device 38, reflected in the vendor criteria, is updated accordingly. Thus, the system evolves dynamically to continuously provide an increasingly effective selection of parties to particular transactions. Should the rating of the seller by the buyer be negative in any aspect, the negative rating is added to the number of previous negative ratings, if any, pertaining to the particular seller. When the cumulative number of negative ratings reaches a predetermined threshold number, a warning is issued to the seller. If the total number of negative ratings does exceed the threshold, the seller is placed on a “probation” status.

The following fictitious scenarios are provided as examples of how the method and apparatus of the present invention serve to complete particular transactions. Thus, in a first example, a system-qualified buyer, a manufacturer of cosmetic products, is about to launch a new cosmetic product and requires packaging for the product. The buyer's packaging engineer has developed specifications for a folding carton and forwarded those specifications to the buyer's purchasing agent. Buyer's quality control unit has informed the purchasing agent of certain quality control requirements for the cartons, including that Good Manufacturing Practices (GFM) must be followed, and that one of every two hundred pieces must be sampled. In addition, the supplier, or seller, must be ISO 9000 certified. Buyer's marketing unit has advised the purchasing agent that time is of the essence and that one-thousand samples of the folding cartons are needed for a trade show scheduled to take place in three weeks. Buyer's sales unit has advised the purchasing agent that the initial order will be for twenty-five thousand folding cartons. Buyer's production unit has informed the purchasing agent that the product is scheduled for packaging in a contract packaging plant in three and one-half weeks. The contract packaging plant is located near St. Louis, approximately one-thousand miles from buyer's headquarters in New York City.

Using a desk-top computer, the purchasing agent accesses system 10 via the world wide web. After successfully logging into system 10, he proceeds to enter a purchase request based upon the schedule of requirements provided by engineering, quality control, marketing, sales and production, as outlined above. The system presents a choice of commodities, and the purchasing agent selects folding cartons. The system then brings up a screen pertaining to folding cartons and the purchasing agent selects the style of the carton needed. He enters the dimensions of the carton in fields provided for such information, and uses a pull-down menu to select the grade of cardboard required. He then proceeds to select the colors to be printed on the carton, using a standard color matching system, such as the Pantone Matching System. He then enters a series of further requirements, indicating that the carton will be high gloss UV coated, and that a logo of given dimensions will be hot foil stamped at two positions on the carton and embossed on the front panel of the carton. Since the carton is a new item, no entry is made of a previous price paid or any deviation from such a price.

The purchasing agent then indicates that a split shipment is required, entering in a first field that one-thousand cartons are needed in three weeks, and entering in another field that the balance of the twenty-five thousand carton order is needed in three and one-half weeks. In order to minimize freight, he enters the zip code of the packaging plant and selects a radius of two-hundred miles.

The purchasing agent then goes to a quality section and selects “cosmetic”, GMP level 2, and ISO 9000. He then selects the desired sampling, indicating one out of every two-hundred pieces must be checked. At an appropriate prompt, he downloads into the system an engineering drawing furnished to him by the packaging engineer. Finally, he indicates that any quotes must be completed by 2:30 PM the next afternoon and that the results should be E-mailed to him, requesting, in this instance, that he be furnished with the five most favorable quotes. He then initiates the request for a quote.

The system acknowledges receipt of the request for a quote and indicates that results will be E-mailed to the purchasing agent at 2:30 PM the next day, as requested. Then, utilizing buyer's previously stored basic requirements together with the specific tangible and intangible requirements of this particular purchase request, the system screens all possible system-qualified sellers to find a group of system-qualified sellers capable of satisfying all of the requirements of the buyer in this particular request. In this instance, the system establishes a group of fourteen such sellers. The system then automatically screens the individual requirements of the fourteen sellers of the selected group against the composite of criteria stored in the system pertaining to the buyer and yields a sub-group of nine sellers willing to sell to the buyer. (The screening revealed that the buyer averages seventy-one days to pay bills, which was indicated as unacceptable to four of the sellers of the group, while a fifth seller indicated it would not accept orders for less than one-hundred-thousand pieces.) The nine sellers of the sub-group are E-mailed the request for a quote.

Eight of the nine sellers of the sub-group respond to the request for a quote in a timely manner. The eight timely responses are sorted automatically by the system and, at 2:30 PM the next day, the five lowest price quotes are E-mailed to the buyer, as requested, along with information pertaining to performance histories of the sellers. At this stage, the buyer and the sellers remain anonymous. The purchasing agent reviews the five quotes and decides to discard the lowest price quote because the corresponding performance history indicates only one successful job and one marginal job. The next lowest quote (3% higher than the lowest quote) also is discarded on the basis that the corresponding seller is new to the system and has no history. The purchasing agent opts for the third lowest quote (8% higher than the lowest quote) based upon a performance history which indicates seven successful jobs and no complaints. He chooses to respond to the system by E-mail rather than logging back in.

Upon receipt of the purchasing agent's E-mail response, the system automatically notifies the selected seller of the selection and the selected seller is instructed to remit the system-required fee. The selected seller wire transfers the fee and the system automatically identifies the buyer to the seller and the seller to the buyer and the transaction goes to completion. A purchase order is issued by the buyer to the seller, and the seller commences to fill the order.

Three weeks later, one-thousand sample cartons are delivered to buyer's New York City headquarters, and twenty-four thousand cartons are sent to the St. Louis facility. The buyer pays the seller in eighty-six days. The system sends the buyer a follow-up form, and the buyer gives the seller a very high satisfaction rating. The rating is entered into the system and the seller's performance index is automatically adjusted upwardly. The system sends a follow-up form to the seller, and the seller notes that the buyer paid in eighty-six days, which is twenty-six days beyond the terms of the transaction. The information is entered into the system and the buyer's credit composite automatically is adjusted downwardly.

In a second example, the system-qualified buyer is a large national bakery products company. The buyer uses resource planning software for supply chain management so that all inventory is managed automatically. Thus, the buyer has stored information, including specifications, engineering drawings and artwork for each of its folding cartons in an arrangement similar to that described hereinabove, in connection with FIG. 5A. When the quantity of a particular folding carton reaches a pre-programmed trigger point, the stored information is forwarded, automatically, in the form of a request for a quote, in standardized file format, to the sourcing engine of a system constructed in accordance with the present invention. The request is sent via E-mail and includes carton dimensions, carton style, printing and coating specifications, grade and thickness of cardboard, the quantity needed, where the cartons are to be shipped, the last price paid, an acceptable level of upward deviation, a schedule of release dates over a six month period, and the date/time when quotes must be received.

When the request reaches the sourcing engine, the information in the request, together with the global constraints of the buyer (already stored in the system) is used to establish a group of system-qualified sellers able to meet the requirements of the buyer's request for a quote. In this particular example, the information in the request indicates that the buyer wants to do business only with sellers who have sales in excess of $5,000,000, only with sellers who warehouse inventory and will release inventory over six months, and only with sellers who follow FDA procedures for food packaging, and the system establishes a group of thirty-one sellers who can satisfy the criteria. The system then checks to see if the buyer satisfies the individual criteria required by each of the sellers. Since the buyer pays its bills in an average of thirty-three days and has a very strong financial statement, a satisfactory match is indicated between the buyer and all thirty-one of the sellers and a request for a quote is forwarded to all of the sellers in the group.

When the date/time arrives, twenty-eight of the thirty-one sellers have responded with a quote. Two of the twenty-eight quotes are outside the predetermined price deviation and are discarded by the system. The remaining twenty-six quotes are sorted in ascending order. In this instance, the buyer has authorized the system to select the lowest price quote for automatic completion of the transaction. Accordingly, the system notifies the seller that the seller has been selected. The seller then wire transfers the system-required fee and the buyer's latest artwork and CAD drawings are sent to the seller directly from the system. The system identifies the buyer to the seller and the seller to the buyer and the transaction goes forward to completion.

Six weeks later, the first shipment arrives on time. The buyer pays the seller twenty-seven days later. The system sends a rating request to the buyer who automatically responds with an acceptable rating. The system sends a rating request to the seller who rates the buyer as a good customer. Both the buyer's and the seller's performance composites are adjusted upwardly.

In FIG. 8, another system constructed and operated in accordance with the present invention is shown diagrammatically at 110 and is seen to include a computer 112 linked to a requester input device shown in the form of a requester terminal 114 through a requester interface 116 and linked to a number of satisfier input devices shown in the form of satisfier terminals 120 through corresponding satisfier interfaces 122.

In order to enter system 110, a potential requester of selected requirements must first be qualified to serve as a party to an arrangement accomplished by the system. Likewise, a potential satisfier of specific requirements must be qualified in order to be made available as a party in the system 110. Turning now to FIG. 9, a requester is shown in the form of a health-care provider, such as a physician, desiring to complete an arrangement with a number of participants in a clinical study proposed by the physician. The physician may become system-qualified by inputting into the computer 112 qualification information in the form of a first predetermined composite of criteria representing the physician. The composite of criteria includes information about the physician and is entered into the computer 112 in a standardized format. The information may be composed of both public information and non-public information. The information is verified and may be combined with further information furnished by an outside source to establish a more complete composite of criteria pertaining to the physician. The verification, or validation, preferably is accomplished by an intermediary, upon release of the intermediary by the physician to perform such validation. If, as a result of the validation process, it is determined that more information is required, the physician is informed and may enter the required information. If the validation process indicates that the physician cannot be qualified to enter the system, the physician is notified of the physician's ineligibility. Upon completion of a successful validation process, the complete composite of criteria pertaining to the physician, in the form of a physician profile, is generated and stored in the system 110 as a physician database. The composite of criteria, or physician profile, may include, but is not limited to, such information as particular areas of interest, specialties, sub-specialties, authored papers and other works, participation in studies, attendance at conferences, affiliations with hospitals and other health-care facilities, and geographic location. In addition, the physician may choose to include certain global constraints, such as minimum health requirements in a potential participant in the clinical study, geographical location of the potential participant, and like constraints which will be common to all requests to be entered into the system by the physician. The system now is available for use by the system-qualified physician.

Referring now to FIG. 10, a satisfier in the form of a potential participant in a clinical study is shown as a candidate who may become system-qualified by inputting into the computer 112 qualification information in the form of a second predetermined composite of criteria representing the candidate. The second composite of criteria includes information about the candidate and is entered into the computer 112 in a standardized format. The information may be composed of both public and non-public information. The second composite of criteria includes satisfaction criteria pertaining to the ability of the candidate to satisfy specific requirements, and requesting criteria pertaining to requirements of the candidate in a particular arrangement in order for the candidate to enter into an arrangement with a particular physician. The satisfaction criteria may include, but are not limited to, general health, specific symptoms, proven ability to follow instructions, disciplinary orientation, and the like, as well as geographic location. The requesting criteria may include, but are not limited to, physician characteristics as well as characteristics pertaining to particular clinical studies, such as frequency of medication, frequency of follow-up, proximity of follow-up locations, and potential side effects and benefits, required by the candidate before the candidate will agree to enter into an arrangement with a particular physician in a particular clinical study. The information is verified and may be combined with further information furnished by an outside source to establish a more complete composite of criteria pertaining to the candidate. The verification, or validation, preferably is accomplished by an intermediary, upon release of the intermediary by the candidate to perform such validation. If, as a result of the validation process, it is determined that more information is required, the candidate is informed and may enter the required information. If the validation process indicates that the candidate cannot be qualified to enter the system, the candidate is notified of the candidate's ineligibility. Upon completion of a successful validation process, the complete composite of criteria pertaining to the candidate, in the form of a seller profile, is generated and stored in the system 110 as a candidate database. The composite of criteria, or candidate profile, thus may include, but is not limited to, such information as ability to satisfy requirements of clinical studies, and geographic location. The candidate now is available to participate in the system as a system-qualified candidate.

Turning now to FIG. 11, a system-qualified physician establishes a schedule of selected requirements required by the physician for a clinical study and enters a request for candidates based upon those selected requirements. As seen in FIG. 8, the request is entered at 140 via an interface 116 which may utilize the world-wide web, a predetermined E-mail format, or by some ubiquitous manner tied into the physician's own computer system to transmit the candidate request to the computer 112. Utilizing authentication data, the identity of the physician is confirmed and entry is allowed of detailed specifications pertaining to the arrangement. The physician also enters certain desirable intangible factors and/or constraints, such as, but not limited to, age of the candidate, sex of the candidate, geographic location, and past performance. All of the information then is forwarded to a sourcing engine in the form of a request for candidates.

As seen in FIGS. 12 through 12C, the request for candidates received at the sourcing engine is processed in the computer 112 to determine if there are any system-qualified candidates available in the system for filling the request by being able to meet the schedule of requirements portion of the request for candidates, and then to determine if any such available candidates meet the intangible factors included in the request for candidates. If there are no such candidates available in the system, the physician is informed of that fact and is given an opportunity to refine the request for candidates and resubmit the refined request. If there are system-qualified candidates available in the system able to meet all of the requirements set forth in the request for candidates, these system-qualified candidates are placed in a selected group established by comparing in the computer 112 the schedule of requirements provided by the physician with the satisfaction criteria of the second predetermined composite of criteria entered by each of the candidates. Then the requesting criteria of each candidate of the selected group of system-qualified candidates is compared, in the computer 112, to the first predetermined composite of criteria representing the physician. Where the first predetermined composite of criteria does not meet the requesting criteria of a candidate of the selected group, the request is not submitted to that candidate. Where the first predetermined composite of criteria does meet the requesting criteria of a candidate, the candidate is included in a sub-group of system-qualified candidates willing to enter into an arrangement with the system-qualified physician entering the candidate request. The request for candidates then is outputted from the computer 112 to each candidate in the sub-group, as illustrated at 142 in FIG. 8, and the candidates are given an opportunity to respond to the request for candidates. The candidates in the sub-group may be provided with a fixed time by which a response is required.

Timely responses by the candidates in the sub-group are inputted into the computer 112, as shown at 144 in FIG. 8. Should a response not be timely, the response is rejected and the corresponding candidate is notified automatically that the candidate's response is rejected by the system. If an adequate number of timely responses are not received, the physician is notified of the lack of interest in the request as set forth by the physician and the physician is given an opportunity to modify the request and resubmit the modified request. If an adequate number of responses are received, a limited number of these responses are outputted for submission to the physician, as indicated at 146 in FIG. 8. The physician then selects the desired candidates. Up to this point, the identity of the physician remains unknown to the candidates and the identity of each candidate remains unknown to the physician. Upon inputting the candidates selected by the physician, as depicted at 148 in FIG. 8, the physician's selection of each candidate is outputted and is transmitted to the selected candidates, all while still maintaining the anonymity of both the physician and the candidates. The system then releases the identity of each candidate to the physician and the identity of the physician to each candidate for completion of the arrangement.

Referring now to FIG. 13, in system 110, upon completion of the arrangement, the physician is obligated to rate the performance of each candidate and each candidate is obligated to rate the performance of the physician. The performance rating of the physician by the candidates is inputted into the computer 112 and the data pertaining to the physician, reflected in the first predetermined composite of criteria, is updated accordingly. The performance rating of the candidates by the physician is inputted into the computer 112 and the data pertaining to the candidates is updated accordingly. Thus, the system evolves dynamically to continuously provide an increasingly effective selection of parties to particular arrangements. Should the rating of any candidate by the physician be negative in any aspect, the negative rating is added to the number of previous negative ratings, if any, pertaining to the particular candidate. When the cumulative number of negative ratings reaches a predetermined threshold number, a warning is issued to the candidate. If the total number of negative ratings does exceed the threshold, the candidate is placed on a “probation” status.

In a manner similar to that described above in connection with FIGS. 8 through 13, a pharmaceutical company is able to place a request for participants in a particular clinical trial, the participants being both physicians and patients. In that case, the pharmaceutical company is in the position of the requester, and the physicians and patients are in the position of the satisfiers. Alternately, the physicians initially are satisfiers to the pharmaceutical company requester and, subsequently, the patients are candidates responding to a request for candidates entered by the selected physicians who then become requesters.

System 110 is available for the referral of a patient by an examining physician to a treating physician, especially where it is desired to match difficult and highly unusual medical cases with specialist physicians. Thus, where an examining physician observes particular symptoms in a patient being examined, and wishes to refer the patient to a physician familiar with the treatment of patients exhibiting such symptoms, the examining physician enters system 110 as a requester, and the treating physician becomes a satisfier. As described above, the examining physician and the treating physician become system-qualified and enter data pertaining to the particular arrangements which the physicians are willing to enter. The examining physician, as requester, enters a schedule of selected requirements, in the form of observed symptoms, as well as other requirements, and the system processes the information to identify treating physicians available as satisfiers.

In the arrangement depicted in FIGS. 14 through 19, the requester comprises a provider of information, and the satisfier includes a party interested in receiving the information provided by the requester. Thus, for example, as depicted in FIG. 14, where the requester is the marketing department of a pharmaceutical company wishing to establish, with precision, a receptive audience among either physicians or patients for specific drug information, the target recipients are chosen from qualified physicians or patients in system 210. System 210 includes a computer 212 linked to a requester input device shown in the form of marketing department terminal 214 through a marketing department interface 216 and linked to a number of satisfier input devices shown in the form of recipient terminals 220, through recipient interfaces 222. Suitable inputs and outputs are shown at 240, 242, 244, 246 and 248, in a manner similar to that described above in connection with corresponding inputs and outputs shown in FIGS. 1 and 8.

Following a procedure similar to that set forth above, the marketing department becomes system-qualified, as in FIG. 15, and potential recipients become system-qualified, as in FIG. 16. The marketing department then establishes a schedule of requirements for a target market and enters a target request into the system 210, as illustrated in FIG. 17. Alternately, information pertaining to recurrent target markets is stored and an automated system periodically initiates a target request, as seen in FIG. 17A. In either procedure, the target request is processed to establish precisely identified recipients interested in receiving the information to be disseminated by the marketing department, as seen in FIGS. 18 through 18B. Ratings are submitted for refining the operation, as illustrated in FIG. 19.

The following fictitious scenarios are provided as additional examples of how the method and apparatus of the present invention serve further to complete particular arrangements. Thus, a pharmaceutical company has a new allergy drug ready for widespread clinical testing and wishes to establish a clinical trial utilizing physicians and patient participants. In addition to treating an allergy, the drug has certain observed benefits; namely, promotes mild to moderate hair growth in men and in women with pattern baldness, and reduces serum cholesterol levels by about two to five percent. The drug is to be taken once a week with a minimum of eight ounces of water, on an empty stomach, upon rising, with the next meal taking place a minimum of two hours after ingestion. If the drug is taken within two hours of eating fatty food, the drug will be absorbed and passed through the digestive system. Earlier trials have identified certain negative side effects in some patients; namely; a slight to moderate elevation in blood pressure accompanied by a slightly accelerated heartbeat, nausea, cramps and diarrhea, and dizziness and vertigo. All of the above information is to be included in a schedule of selected requirements for the choice participants in the clinical trial.

The pharmaceutical company has an extensive database of physicians, the database including information pertaining to particular areas of interest and sub-specialties of the physicians. Another database is dedicated to candidates who are potential participant patients, including information pertaining to condition, symptoms and lifestyle. The company requires the identification of general practitioner physicians who are interested in participating in clinical trials, who have a sub-specialty or an expressed interest in cardiovascular disease, as demonstrated by attendance at at least one cardiovascular conference in the past year, and who are affiliated with an accredited teaching hospital in the United States.

Patients sought for the clinical study must be in generally acceptable health and have appropriate allergy symptoms. In addition, a patient must demonstrate a proven capability to follow instructions with regard to taking prescription medicine, and must be within forty-five minutes travel time from a study physician and the associated teaching hospital. Secondarily, the patient may have pattern baldness and/or slightly elevated cholesterol. The patient must not have elevated blood pressure, gastro-intestinal problems, or be prone to dizzy spells or vertigo.

Utilizing the above-outlined factors, the company will employ the present invention to first identify physicians who meet the company's requirements for the clinical trial and whose own individual criteria for participation is satisfied. These criteria include, inter alia, details of the sponsoring company, protocol, interest in particular drugs, interest in particular diseases, dedicated time required, and potential for follow-up. Once potential physicians are determined, geographic location is utilized as part of the criteria necessary to identify potential participants who are both acceptable to the company (as determined by the satisfaction of criteria) and who have an interest in participating in the clinical trial, as evidenced by the satisfaction of their own criteria. These criteria include, inter alia, company conditions, frequency of medication, frequency of follow-up, proximity to follow-up facility, and potential side-effects and benefits.

The present invention then will determine a best fit for the particular clinical trial. Once the trial has been completed, the company will rate the compliance and performance of the physicians, the physicians will rate the company and the compliance of the patient participants, and the patient participants will rate the physicians. The rating data will be added dynamically to the profiles of the parties for later use.

In another example, a multi-national pharmaceutical company has a new cholesterol-lowering drug. In addition, the drug exhibits several positive side-effects for specific unrelated conditions. The company wishes to custom tailor specific information for individual physicians, based upon each physician's level of interest in both the primary and the specific secondary benefits of the drug.

The company uses the present invention employing a minimum set of selected requirements, such as the designation of physicians who prescribe cholesterol-lowering drugs, and who serve a patient population that can afford the drug, and optional criteria, such as any or all of the secondary benefits, to identify physicians who would constitute a good fit from the perspective of the company. The present invention then ascertains, from the standpoint of each physician, utilizing the physician's own predetermined criteria, whether a physician indeed wants to receive such information and, if a physician does want to receive information, which specific areas related to the drug are of interest, and what level of detail.

The present invention then delivers the information via any one of a number of delivery systems, including E-mail, a private web page, to a PDA or hand-held, hard copy, or through a drug company representative. Once the information is received by a physician, the physician will rate the information for interest and appropriateness. The rating is used by the system as a dynamic and instantaneous feed-back mechanism to further customize the content and level of detail required for each responding physician. The company will rate the physician based upon a predetermined level of response.

In still another example, a twenty-eight year old woman in Chicago has a seizure and subsequently is diagnosed with a rare brain tumor. A complex procedure involving microsurgery and radiation is required to remove the growth. There are no local neurosurgeons with experience in this procedure. The woman's physician utilizes the present invention, entering such selected requirements as the woman's vital statistics, condition, diagnoses, the distance she is willing to travel, and her insurance information. A preference is indicated for a neurosurgeon who has the most experience with the particular tumor.

Based upon the selected requirements and criteria, the present invention identifies specialists with strong experience in treating the particular tumor involved, and then compares the fit against what each specialist requires in a patient, such as, inter alia, sex, age, general health, and tumor size, as well as insurance information. A match is found with a physician in Toronto who has completed fourteen successful procedures of the nature required, within the past twelve months.

After the procedure, the primary care physician rates the specialist, supplying rating information pertaining to the performance of the specialist. The specialist rates the primary care physician based upon the representation of the initial requirements and criteria by the primary care physician.

It will be seen that the method and system of the present invention reduces the time and complexity of choice in completing a transaction between a buyer and a seller of goods or services, as well as other arrangements between a requester and a satisfier, enabling increased accuracy with minimal time and effort, and concomitant decreased cost, in effecting an arrangement which meets criteria established by both the parties in a particular market. The completion of the transaction or arrangement in the present invention is effected automatically, thereby conserving the time and resources of the parties in accomplishing an arrangement meeting all of the requirements of both parties. The result is improved profitability for the seller and lower pricing for the buyer, and better matching of satisfiers with a requester, all accomplished automatically. As such, the method and system attains the several objects and advantages summarized above, namely: Automatically selects parties for a particular transaction or arrangement, from qualified requesters and satisfiers, such as qualified buyers and qualified sellers available in a market for goods or services; takes into account composites of criteria established by both requesters and satisfiers, such as buyers and sellers, in order to effect rapid and accurate selection of parties to a particular arrangement, such as a sales transaction; enables an evaluation based upon past performance of potential parties to an arrangement, such as a transaction in the automatic selection of parties to a particular transaction; provides increased flexibility in completing an arrangement, such as a transaction between selected parties to a sales transaction; facilitates completion of a particular sales transaction through automatically furnishing proprietary items, such as technical data, as well as detailed specifications pertinent to the transaction; enables a purchaser to obtain rapid and accurate fulfillment of specific purchase requests at an advantageous price in fields which offer a multiplicity of suppliers; attains improved profitability for suppliers; reduces transaction costs for both buyers and sellers; promotes a dynamic system which evolves continually into a more effective selection of parties to a particular arrangement; provides a reliable system for effecting automatic transactions between buyers and sellers of goods or services at more advantageous prices and conditions.

It is to be understood that the above detailed description of preferred embodiments of the invention is provided by way of example only. Various details of design, construction and procedure may be modified without departing from the true spirit and scope of the invention, as set forth in the appended claims.

The embodiments of the invention in which an exclusive property or privilege is claimed are defined as follows:

1. A method of operating a computer system for the automatic selection of parties to an arrangement between a system-qualified requester of selected requirements and a system-qualified satisfier of specific requirements, the method comprising the steps of:
inputting into the computer system a first predetermined composite of criteria representing each requester qualified to enter the computer system as a system-qualified requester;
inputting into the computer system a second predetermined composite of criteria representing each satisfier qualified to serve as a system-qualified satisfier in the computer system, the second predetermined composite of criteria including satisfaction criteria pertaining to the ability of the satisfier to satisfy specific requirements, and requesting criteria pertaining to requirements of the satisfier in a particular arrangement in order for the satisfier to enter into an arrangement with a particular requester;
entering into the computer system a request for a satisfier by a requester identified as a system-qualified requester, the request for a satisfier including a schedule of requirements established by the system-qualified requester;
comparing in the computer system the schedule of requirements with the satisfaction criteria of the second predetermined composite of criteria to establish a selected group of system-qualified satisfiers able to meet the schedule of requirements;
comparing in the computer system the requesting criteria of each satisfier of the selected group of system-qualified satisfiers with the first predetermined composite of criteria to establish a sub-group of satisfiers willing to enter into an arrangement with the system-qualified requester entering the request for a satisfier;
outputting from the computer system the request for a satisfier for submission to the sub-group of system-qualified satisfiers for timely responses by satisfiers of the sub-group of system-qualified satisfiers;
inputting into the computer system timely responses by responding satisfiers of the sub-group of system-qualified satisfiers, and outputting from the computer system the timely responses inputted by the responding satisfiers for selection by the requester of a response from among those timely responses inputted by responding satisfiers;
inputting into the computer system a requester selected response and outputting from the computer system the requester selected response to notify the satisfier corresponding to the selected response of the selection of the selected response by the requester; and
outputting from the computer system to the requester the identity of the satisfier and outputting from the computer system to the satisfier the identity of the requester for completion of the arrangement.

2. The method of claim 1 including inputting into the computer system, subsequent to completion of the arrangement, a rating by the requester of the performance of the satisfier, and including the rating in the satisfaction criteria of the second predetermined composite of criteria.

3. The method of claim 1 including inputting into the computer system, subsequent to completion of the arrangement, a rating by the satisfier of the performance of the requestor, and including the rating in the first predetermined composite of criteria.

4. The method of claim 1 wherein the arrangement comprises a clinical trial, the requestor comprises a health-care provider, and the satisfier includes a candidate for potential participation in the clinical trial.

5. The method of claim 1 wherein the arrangement comprises a clinical trial, the requestor comprises a pharmaceutical provider, and the satisfier includes a health-care provider.

6. The method of claim 1 wherein the arrangement comprises the dissemination of information, the requester comprises an information provider, and the satisfier includes a party interested in receiving the information.

7. The method of claim 1 wherein the arrangement comprises the referral of a patient exhibiting particular symptoms, the requester includes a referring physician having observed the symptoms, and the satisfier includes a referred physician familiar with treatment of the symptoms.

8. A computer system operated for the automatic selection of parties to an arrangement between a system-qualified requester of selected requirements and a system-qualified satisfier of specific requirements, the computer system comprising:
an inputting device for:
inputting into the computer system a first predetermined composite of criteria representing each requester qualified to enter the computer system as a system-qualified requester;
inputting into the computer system a second predetermined composite of criteria representing each satisfier qualified to serve as a system-qualified satisfier in the computer system, the second predetermined composite of criteria including satisfaction criteria pertaining to the ability of the satisfier to satisfy specific requirements, and requesting criteria pertaining to requirements of the satisfier in a requester in order for the satisfier to enter into an arrangement with a particular requester; and
entering into the computer system a request for a satisfier by a requester identified as a system-qualified requester, the request for a satisfier including a schedule of requirements established by the system-qualified requester;
such that the computer system compares:
the schedule of requirements with the satisfaction criteria of the second predetermined composite of criteria to establish a selected group of system-qualified satisfiers able to meet the schedule of requirements; and
the first predetermined composite of criteria with the requesting criteria of each satisfier of the selected group of system-qualified satisfiers to establish a sub-group of satisfiers willing to enter into an arrangement with the system-qualified requester entering the request for a satisfier; and
an outputting device for:
outputting from the computer system the request for a satisfier for submission to the sub-group of system-qualified satisfiers for timely responses by satisfiers of the sub-group of system-qualified satisfiers;
the inputting device further being operative for:
inputting into the computer system timely responses by responding satisfiers of the sub-group of system-qualified satisfiers, and outputting from the computer system the timely responses inputted by the responding satisfiers for selection by the requester of a response from among those timely responses inputted by responding satisfiers; and
inputting into the computer system a requester selected response and outputting from the computer system the requester selected response to notify the satisfier corresponding to the selected response of the selection of the selected response by the requester; and
the outputting device further being operative for:
outputting from the computer to the requester the identity of the satisfier and outputting from the computer to the satisfier the identity of the requester for completion of the arrangement.

9. The computer system of claim 8 wherein the inputting device is further operative for inputting into the computer system, subsequent to completion of the arrangement, a rating by the requester of the performance of the satisfier, and including the rating in the satisfaction criteria of the second predetermined composite of criteria.

10. The computer system of claim 8 wherein the inputting device is further operative for inputting into the computer system, subsequent to completion of the arrangement, a rating by the satisfier of the performance of the requester, and including the rating in the first predetermined composite of criteria.

11. An improvement in a method of operating a computer system for the automatic selection of parties to an arrangement to be completed between a system-qualified requester of selected requirements and a system-qualified satisfier of specific requirements, wherein a first predetermined composite of criteria representing each requester qualified to enter the computer system as a system-qualified requester is inputted into the computer system and a second predetermined composite of criteria representing each satisfier qualified to serve as a system-qualified satisfier in the computer system is inputted into the computer system, the second predetermined composite of criteria including satisfaction criteria pertaining to the ability of the satisfier to satisfy specific requirements, and requesting criteria pertaining to requirements of the satisfier in a particular arrangement in order for the satisfier to enter into an arrangement with a particular requester, the improvement comprising: inputting into the computer system, subsequent to completion of the arrangement, a rating by the requester of the performance of the satisfier, and including the rating in the satisfaction criteria of the second predetermined composite of criteria.

12. An improvement in a method of operating a computer system for the automatic selection of parties to an arrangement to be completed between a system-qualified requester of selected requirements and a system-qualified satisfier of specific requirements, wherein a first predetermined composite of criteria representing each requester qualified to enter the computer system as a system-qualified requester is inputted into the computer system and a second predetermined composite of criteria representing each satisfier qualified to serve as a system-qualified satisfier in the computer system is inputted into the computer system, the improvement comprising: inputting into the computer system, subsequent to completion of the arrangement, a rating by the satisfier of the performance of the requester, and including the rating in the first predetermined composite of criteria.

13. In a computer system operated for the automatic selection of parties to an arrangement to be completed between a system-qualified requester of selected requirements and a system-qualified satisfier of specific requirements, wherein an inputting device is operative for inputting into the computer system a first predetermined composite of criteria representing each requester qualified to enter the computer system as a system-qualified requester and a second predetermined composite of criteria representing each satisfier qualified to serve as a system-qualified satisfier in the computer system, the second predetermined composite of criteria including satisfaction criteria pertaining to the ability of the satisfier to satisfy specific requirements, and requesting criteria pertaining to requirements of the satisfier in a particular arrangement in order for the satisfier to enter into an arrangement with a particular requester, the improvement wherein: the inputting device is further operative for inputting into the computer system, subsequent to completion of the arrangement, a rating by the requester of the performance of the satisfier, and including the rating in the satisfaction criteria of the second predetermined composite of criteria.

14. In a computer system operated for the automatic selection of parties to an arrangement to be completed between a system-qualified requester of selected requirements and a system-qualified satisfier of specific requirements, wherein an inputting device is operative for inputting into the computer system a first predetermined composite of criteria representing each requester qualified to enter the computer system as a system-qualified requester and a second predetermined composite of criteria representing each satisfier qualified to serve as a system-qualified satisfier in the computer system, the improvement wherein: the inputting device is further operative for inputting into the computer system, subsequent to completion of the arrangement, a rating by the satisfier of the performance of the requester, and including the rating in the first predetermined composite of criteria.
